(19) United States
(12) Patent Application Publication
(10) Pub. No.: US 2020/0406803 A1
(43) Pub. Date: Dec. 31, 2020

(54) FLOOR CARPET WITH ELECTROMAGNETIC SHIELDING

(71) Applicant: GM Global technology Operations LLC, Detroit, MI (US)

(72) Inventors: Alejandro Hernandez Covarrubias, Metepec (MX); Celia Marcela Arroyo Avila, Mexico City (MX)

(21) Appl. No.: 16/455,044

(22) Filed: Jun. 27, 2019

(51) Int. Cl. B60N 3/04; D06N 7/00

(52) U.S. Cl. CPC B60N 3/048; B32B 5/022; D06N 7/0042; D06N 7/0026

(57) ABSTRACT

A floor carpet for an automobile comprises a first layer of polyester carpet pile, a second layer including an electromagnetic shield, the electromagnetic shield including a grid of conductive metal fibers molded into a matrix of thermoplastic material, and a third layer including a sound dampening backing made from one of wool and polyurethane, wherein, the first layer, second layer, and third layer are molded together as a unitary piece that is shaped to conform to the contour of a floor panel within an automobile and adapted to be immovably installed within the automobile, the electromagnetic shield extending across substantially all of the floor carpet to provide electromagnetic shielding across substantially the entire floor of the automobile.

### INTRODUCTION

The present disclosure relates to a floor carpet for the interior of an automobile that includes an electromagnetic shield incorporated therein.

More and more, vehicles are being developed with hybrid and full electrical powertrains. These vehicles require the use of high voltage batteries and electrical cables to store and transfer electricity for the electrical components within the vehicle. While generally, such batteries and cables are positioned outside the passenger compartment of the vehicle, electromagnetic radiation can pass into the vehicle. In many instances, batteries and cables are mounted below the floor of the vehicle. To protect the passengers and sensitive electronics within the vehicle from exposure to electromagnetic emissions, it is desirable to control the amount of electromagnetic emissions that pass through the floor of the vehicle into the passenger compartment.

Thus, there is a need for a floor carpet for an automobile that includes an electromagnetic shield incorporated therein.

### SUMMARY

According to several aspects of the present disclosure, a floor carpet for an automobile comprises a first layer of carpet pile, a second layer including an electromagnetic shield, and a third layer including a sound dampening backing, wherein the first layer, second layer, and third layer are molded together as a unitary piece.

According to another aspect of the present disclosure, the carpet pile is polyester.

According to another aspect of the present disclosure, the backing is wool.

According to another aspect of the present disclosure, the backing is polyurethane.

According to another aspect of the present disclosure, the electromagnetic shield includes a grid of conductive material molded within a matrix of formable material.

According to another aspect of the present disclosure, the amount of electromagnetic shielding provided by the floor carpet can be tuned by varying the density of the grid of conductive material.

According to another aspect of the present disclosure, the grid of conductive material includes fibers made from an electrically conductive material.

According to another aspect of the present disclosure, the fibers are made from an electrically conductive metal.

According to another aspect of the present disclosure, the matrix of formable material is a thermoplastic.

According to another aspect of the present disclosure, the floor carpet is shaped to conform to the contour of a floor panel within an automobile and to be immovably installed within the automobile.

According to another aspect of the present disclosure, the electromagnetic shield extends across substantially all of the floor carpet to provide electromagnetic shielding across substantially the entire floor of the automobile.

According to another aspect of the present disclosure, the electromagnetic shield is located at a position within the floor carpet to provide localized electromagnetic shielding at a specific location.

According to another aspect of the present disclosure, the floor carpet is portable and can be moved within an automobile or selectively used in different automobiles.

According to several aspects of the present disclosure a floor carpet for an automobile comprises a first layer of polyester carpet pile, a second layer including an electromagnetic shield, the electromagnetic shield including a grid of conductive metal fibers molded into a matrix of thermoplastic material, and a third layer including a sound dampening backing made from one of wool and polyurethane, wherein, the first layer, second layer, and third layer are molded together as a unitary piece that is shaped to conform to the contour of a floor panel within an automobile and adapted to be immovably installed within the automobile, the electromagnetic shield extending across substantially all of the floor carpet to provide electromagnetic shielding across substantially the entire floor of the automobile.

According to several aspects of the present disclosure, a method of forming a floor carpet having an electromagnetic shield comprises placing an electromagnetic shield between a layer of pile carpet and a backing material, and molding the pile carpet and backing material together, with the electromagnetic shield therebetween.

According to another aspect of the present disclosure, the method further includes thermo-molding the carpet pile, the electromagnetic shield and the backing material together.

According to another aspect of the present disclosure, the method further includes forming a carpet pile in a first mold, removing the carpet pile from the first mold and placing the carpet pile within a second mold, placing an electromagnetic shield within the second mold, and injection molding polyurethane backing material into the second mold to create a mechanical bond between the carpet pile and the backing material, encapsulating the electromagnetic shield therebetween.

According to another aspect of the present disclosure, the method further includes molding a grid of conductive fibers within a matrix of formable material to create an electromagnetic shield.

According to another aspect of the present disclosure, the method further includes varying the density of the grid of conductive fibers to vary the amount of electromagnetic shielding provided by the electromagnetic shield.

According to another aspect of the present disclosure, the method includes molding the pile carpet and backing material together, with the electromagnetic shield therebetween, includes molding the pile carpet and backing material together, with the electromagnetic shield therebetween in a shape that conforms the contour of a floor panel within an automobile.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side sectional view of a floor carpet according to an exemplary embodiment;

FIG. 2 is a close up view of a grid of conductive fibers within a matrix of thermoplastic of an electromagnetic shield within a floor carpet according to an exemplary embodiment;

FIG. 3 is a schematic view of a method of forming a floor carpet having an electromagnetic shield according to an exemplary embodiment; and

FIG. 4 is a schematic view of a method of forming a floor carpet having an electromagnetic shield according to another exemplary embodiment.

### DETAILED DESCRIPTION

The following description is merely exemplary in nature and is not intended to limit the present disclosure, application, or uses. Referring to FIG. 1, a floor carpet 10 for an automobile in accordance with the present disclosure includes a first layer 12 of carpet pile, a second layer 14 that is an electromagnetic shield, and a third layer 16 of sound dampening backing. The first layer 12, second layer 14, and third layer 16 are molded together as a unitary piece to provide a floor carpet 10 for the automobile that includes an electromagnetic shield incorporated therein.

The first layer 12 may be any known floor carpeting adapted for an automobile, such as polyester. The third layer 16 may be made from any material suited for use within an automobile. In one exemplary embodiment, the third layer 16 of the floor carpet 10 is made from wool. Wool will provide good heat insulation and sound dampening qualities that are desired in automobile floor carpeting. In another exemplary embodiment, the third layer 16 of the floor carpet 10 is made from polyurethane. Polyurethane also provides good sound dampening qualities and is suited to molding techniques used to form the floor carpeting 10.

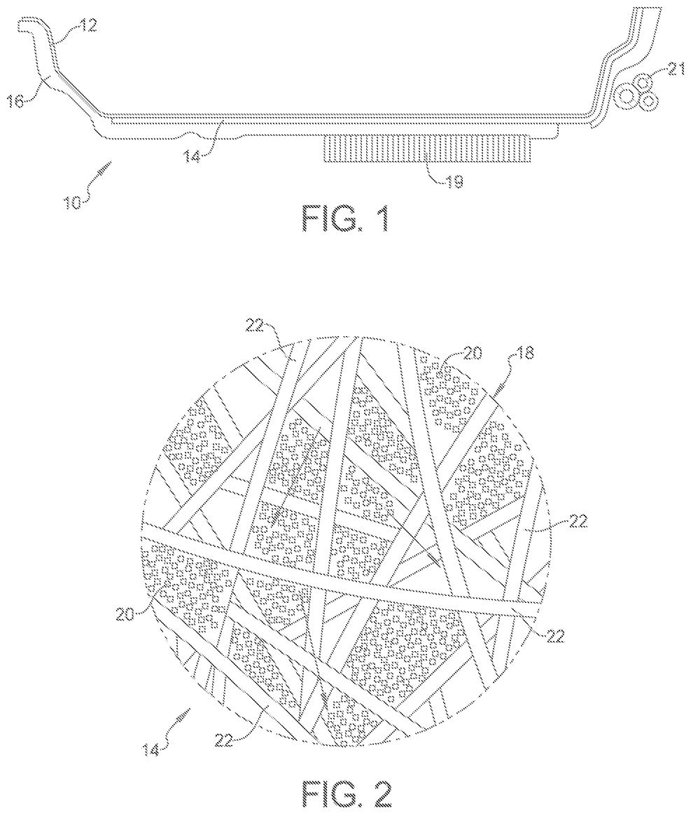

Referring to FIG. 2, the second layer 14, or the electromagnetic shield, includes a grid of conductive material 18 molded within a matrix of formable material 20. The grid of conductive material 18 will absorb electromagnetic emissions from outside the passenger vehicle, blocking at least a portion of the electromagnetic emissions from entering the passenger compartment of the vehicle. Such emissions may come from batteries 19 or electric cables 21.

The amount of electromagnetic emissions that are allowed to pass through the floor carpet 10 is dependent upon the density of the grid of conductive material 18. In an exemplary embodiment, the grid of conductive material 18 includes fibers of conductive material 22. More specifically, the fibers of conductive material 22 are made from an electrically conductive metal, such as copper or nickel. The second layer/electromagnetic shield 14 can be tuned to block more or less of the electromagnetic emissions by varying the density of the fibers 22 that make up the grid of conductive material 18, depending on the type and frequency of electromagnetic emissions.

The grid of conductive material 18 is molded into a matrix of formable material 20. The matrix of formable material 20 may be comprised of any suitable formable substance. In an exemplary embodiment, as shown in FIGS. 1 & 2, the matrix of formable material 20 is a thermoplastic. The thermoplastic will provide added sound dampening qualities and is suitable for the molding techniques used to form the floor carpet 10.

In one exemplary embodiment, the floor carpet 10 is shaped to conform to the contour of a floor panel within an automobile. The floor carpet 10 is installed within the automobile and fits exactly to the contour and size of the floor panel within the automobile. The floor carpet 10 is secured to the floor panel of the automobile. In one exemplary embodiment, the second layer/electromagnetic shield 14 extends across substantially all of the floor carpet 10 to provide electromagnetic shielding across substantially the entire floor of the automobile. Alternatively, in another exemplary embodiment, the second layer/electromagnetic shield 14 is located at a position within the floor carpet to provide localized electromagnetic shielding at a specific location of the floor panel within the automobile.

In another exemplary embodiment, the floor carpet 10 is portable and can be moved within an automobile or selectively used in different automobiles. In this instance, rather than having a shape that contours to the shape and size of the automobile, the floor carpet has a generic round, square, or rectangular shape, or a custom shape to fit within contour features of the floor panel of the automobile, such as a floor mat. This type of floor carpet 10 can be moved within the automobile, or removed from the automobile entirely.

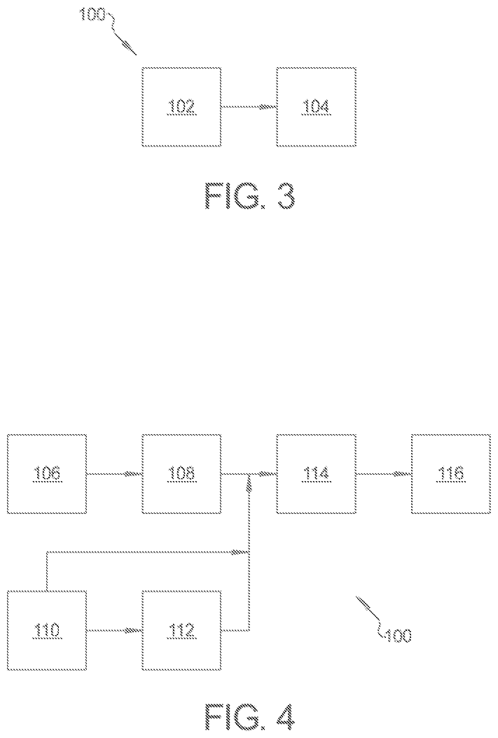

Referring to FIG. 3, a method of forming a floor carpet 10 having an electromagnetic shield is shown generally at 100. Starting at block 102, the method includes placing an electromagnetic shield (second layer) 14 between a layer of pile carpet (first layer) 12 and a backing material (third layer) 16. Moving to block 104, the method includes molding the pile carpet 12 and backing material 16 together, with the electromagnetic shield 14 therebetween. In an exemplary embodiment, the carpet pile 12, the electromagnetic shield 14 and the backing material 16 are thermo-molded together.

Referring to FIG. 4, in an exemplary embodiment, starting at block 106, the method includes forming the carpet pile 12 separately in a first mold. Moving to block 108, the carpet pile 12 is removed from the first mold and placed within a second mold. The second mold will provide the final shape for the floor carpet 10.

At block 110, the electromagnetic shield 14 is formed by molding a grid of fibers of conductive material 22 within a matrix of formable material 20. At block 112, the method includes varying the density of the grid of fibers of conductive material 22 to vary the amount of electromagnetic shielding provided by the electromagnetic shield 14. This step allows the floor carpet 10 to be tuned for a specific application depending on the type and frequency of electromagnetic emissions that the floor carpet 10 is expected to experience.

At block 114, the method includes placing the electromagnetic shield 14 within the second mold, in engagement with the carpet pile 12. If the electromagnetic shield 14 is meant to cover the entire expanse of the floor carpet 10, the electromagnetic shield 14 is aligned with the carpet pile 12 accordingly. If the floor carpet 10 is being designed to provide electromagnetic shielding only within a specified location, the electromagnetic shield 14 is placed within the second mold, in engagement with the carpet pile 12 at the location where electromagnetic shielding is desired.

Moving to block 116, the method includes injection molding a polyurethane backing material 16 into the second mold. The polyurethane material fills the second mold and creates a mechanical bond between the carpet pile 12 and the polyurethane backing material 16. The electromagnetic shield 14 is encapsulated between the carpet pile 12 and the polyurethane backing material 16.

In an exemplary embodiment, the second mold is shaped and sized for a specific application and the method includes molding the pile carpet 12 and backing material 16 together, with the electromagnetic shield 14 therebetween in a shape that conforms the contour of a floor panel within an automobile. The finished floor carpet 10 will be semi-rigid and will match the inner contour of the floor panel of the automobile allowing the floor carpet 10 to be easily installed within the automobile during assembly.

A floor carpet 10 of the present disclosure offers several advantages. These include providing a floor carpet 10 that includes an electromagnetic shield 14 incorporated therein. This reduces assembly time and complexity, and reduces the number of components during assembly of an automobile. Further, the floor carpet 10 of the present disclosure allows the electromagnetic shielding 14 to be tuned for specific applications depending on the type of and frequency of electromagnetic emissions. Finally, the floor carpet 10 of the present disclosure can be designed to provide electromagnetic shielding of the entire floor of the automobile, or alternatively, maybe designed to provide localized electromagnetic shielding at specific locations within the automobile.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A floor carpet for an automobile, comprising:
a first layer of carpet pile;
a second layer including an electromagnetic shield; and
a third layer including a sound dampening backing;
wherein, the first layer, second layer, and third layer are molded together as a unitary piece.

2. The floor carpet of claim 1, wherein the carpet pile is polyester.

3. The floor carpet of claim 1, wherein the backing is wool.

4. The floor carpet of claim 1, wherein the backing is polyurethane.

5. The floor carpet of claim 1, wherein the electromagnetic shield includes a grid of conductive material molded within a matrix of formable material.

6. The floor carpet of claim 5, wherein the amount of electromagnetic shielding provided by the floor carpet can be tuned by varying the density of the grid of conductive material.

7. The floor carper of claim 5, wherein the grid of conductive material includes fibers made from an electrically conductive material.

8. The floor carpet of claim 7, wherein the fibers are made from an electrically conductive metal.

9. The floor carpet of claim 5, wherein the matrix of formable material is a thermoplastic.

10. The floor carper of claim 1, wherein the floor carpet is shaped to conform to the contour of a floor panel within an automobile and to be immovably installed within the automobile.

11. The floor carpet of claim 10, wherein the electromagnetic shield extends across substantially all of the floor carpet to provide electromagnetic shielding across substantially the entire floor of the automobile.

12. The floor carpet of claim 11, wherein the electromagnetic shield is located at a position within the floor carpet to provide localized electromagnetic shielding at a specific location.

13. The floor carpet of claim 1, wherein the floor carpet is portable and can be moved within an automobile or selectively used in different automobiles.

14. A floor carpet for an automobile, comprising:
a first layer of polyester carpet pile;
a second layer including an electromagnetic shield, the electromagnetic shield including a grid of conductive metal fibers molded into a matrix of thermoplastic material; and
a third layer including a sound dampening backing made from one of wool and polyurethane;
wherein, the first layer, second layer, and third layer are molded together as a unitary piece that is shaped to conform to the contour of a floor panel within an automobile and adapted to be immovably installed within the automobile, the electromagnetic shield extending across substantially all of the floor carpet to provide electromagnetic shielding across substantially the entire floor of the automobile.

15. A method of forming a floor carpet having an electromagnetic shield comprising:
placing an electromagnetic shield between a layer of pile carpet and a backing material; and
molding the pile carpet and backing material together, with the electromagnetic shield therebetween.

16. The method of claim 15, including thermo-molding the carpet pile, the electromagnetic shield and the backing material together.

17. The method of claim 15, further including:
forming a carpet pile in a first mold;
removing the carpet pile from the first mold and placing the carpet pile within a second mold;
placing an electromagnetic shield within the second mold; and
injection molding polyurethane backing material into the second mold to create a mechanical bond between the carpet pile and the backing material, encapsulating the electromagnetic shield therebetween.

18. The method of claim 15, further including:
molding a grid of conductive fibers within a matrix of formable material to create an electromagnetic shield.

19. The method of claim 18, including varying the density of the grid of conductive fibers to vary the amount of electromagnetic shielding provided by the electromagnetic shield.

20. The method of claim 15, wherein molding the pile carpet and backing material together, with the electromagnetic shield therebetween, includes molding the pile carpet and backing material together, with the electromagnetic shield therebetween in a shape that conforms the contour of a floor panel within an automobile.
